(19) United States
(12) Patent Application Publication
(10) Pub. No.: US 2004/0236962 A1
(43) Pub. Date: Nov. 25, 2004

(54) Method and apparatus for secure browser-based information service

(76) Inventors: Ping Wah Wong, Sunnyvale, CA (US); Hugh Phu Nguyen, San Jose, CA (US)

Correspondence Address: Ping Wah Wong, 1443 Knowlton Drive, Sunnyvale, CA, 94087, US

(21) Appl. No.: 10/440,787

(22) Filed: May 19, 2003

(51) Int. Cl. H04L 9/00

(52) U.S. Cl. 713/201

(57) ABSTRACT

An end-to-end secure web-based information system is disclosed. The system uses an information server to obtain information from at least one information source. The information is organized into information pages by a page server. A cryptographic engine provides encryption and decryption capabilities for information page addresses corresponding to the hyperlinks on the information pages served by the page server. The information pages are transmitted to client browsers using an encrypted communications protocol, hence the page contents are encrypted during transmission. This system is compatible with client browsers without any additional software or plug-in on the client side. The system is end-to-end secure because both the information page contents and the page addresses are encrypted during transmission.

### BACKGROUND OF THE INVENTION

1. Field of the Invention

This invention relates to methods for providing secure browser-based information services.

2. Background Description

The infrastructure of information service has existed over the global information network for many years. One example is news service in which many host machines store news information that includes newsgroups and news articles. These host machines are known as information sources, and they provide the information to other servers and client users. A client user who wants to have access to the information service would establish a connection to an information source, and then use a piece of client software to access or download the specific information contents of interest to the client user.

In recent years, a new method of providing information service uses a page server on the server side and a browser on the client side. In this new method, an information provider obtains information from at least one information source, stores and organizes the information on the server side, and uses a page server to serve the information in the form of information pages to client users. As a result, a client user can use a browser to view the information pages served by the information provider. A commercial example of such an information service is the browser based news service provided by google.com.

One disadvantage of browser-based information service is that the traffic is not secure because both the page contents (e.g., content of a news article) and the page addresses (which, in this example, correspond to an identification tag of the news article) are sent in clear text. Consequently an eavesdropper who listens into the communication will be able to find out the activities of the user, i.e. find out what information content that the client user reads. A prior art solution to the security problem is to use an encrypted communication protocol, e.g. Secure Socket Layer (SSL), to encrypt the traffic. An advantage of using SSL is that SSL is a proven secure technology. Another advantage of using SSL is that popular browsers support SSL, which means that the deployment of such a solution would not require the client user to install additional software on the client machine. The disadvantage of this approach is that while the page contents are encrypted by SSL, the page request (i.e. a page address) sent from the browser to the server is still unencrypted. The reason that the page address is not encrypted is because the global information network needs to be able to identify the server (the information service) in order to direct the request from the client to the server. Since the page address often contains identifying information such as identification tag to a newsgroup or a news article, privacy and security of the client user cannot be guaranteed.

Services that use anonymous proxy servers to provide anonymous browsing services have been in existence for several years. Suppose a client user wants to obtain a page from an information server in an anonymous fashion. The client can first go to an anonymous browsing service, and then the client makes a request to the information server through the anonymous browsing service provider. To the information server, the page request appears as if it is made by the anonymous browsing service, while in fact the anonymous browsing service is only making the page request on behalf of the client user. When the anonymous browsing service obtains the page from the information server, the service translates the page addresses associated with the hyperlinks on the information page, and then sends the processed information page to the client user. A purpose of translating the page addresses is that when a client user clicks on the hyperlink, the new page request will go back to the anonymous service provider, which will then relay the request to the information server. To safeguard the security and privacy of the client users, it is necessary to protect both the page contents and the page addresses of the sites that a user visits. Typical secure anonymous browsing services use an encrypted protocol, such as SSL, to encrypt the page content. The page addresses associated with the hyperlinks are typically encrypted separately by an encryption means on the server side. Examples of secure anonymous browsing service include idzap.com, anonymizer.com, re-webber.com, and others.

U.S. Pat. No. 5,835,718 describes a server that translates a remote URL (page address in the World Wide Web) into a local URL before a page is served to a client user. The purpose of re-writing a URL is to route the page through a local server so that the activities of the user can be recorded. Although there is a translation in the URL, the information is still sent in clear text. Furthermore, the URL translation is for the purpose of routing the requests through a local server, not for the purpose of providing security via encryption.

There is a need for a secure browser-based information service where a client user can obtain information directly to the information server using a browser on the client side, and at the same time assure the privacy and security of the client user.

### SUMMARY OF THE INVENTION

This invention provides a browser-based information service that provides end-to-end security to the users. The server system consists of an information server, a page server, an address cryptographic engine (ACE), and a storage means. The information server obtains information from at least one information source, organizes the information, and stores the information in a storage means. The page server formats the information into information pages that can be served to client browsers through a global information network. The server system supports at least one encrypted communication protocol so that the page contents transmitted between the server and the browser are encrypted. The ACE provides encryption and decryption capability of page addresses to the information service. The design of the server system is that it provides end-to-end security and privacy where the only requirement to the client user machines is that a browser is available that is capable of handling at least one encrypted communication protocol. There is no requirement of any other hardware, software or plug-in capabilities to the client machines.

When a user connects to the server system using a browser, a page server provides a first information page for the user to communicate with the information service. In one embodiment of the invention, the page server presents a login page so that the user can login into an account on the system. In another embodiment, the page server presents news information to the user without requiring the user to login. Upon user instructions, the page server formats the information into an information page and sends the page to the ACE. The ACE encrypts the page addresses of associated with hyperlinks on the page using a user dependent cryptographic key. The page is then sent to the client user using an encrypted communication protocol.

Using the World Wide Web as an example, an encrypted page address comprises an encrypted uniform resource locator (URL) of the form

https://siteaddress.com/encrypted info

The string “encrypted_info” represents the portion that specifies the information being requested by the client user, and this portion is encrypted. The other portion, i.e. the string “https://siteaddress.com/”, identifies of the address of the information server, and this portion is not encrypted. Therefore if a user makes a request for an information page using the encrypted URL, the global information network will be able to direct the page request from the browser to the server. Consequently, this example illustrates the use of encrypted page addresses to protect the privacy and security of the client user.

When a browser receives a page from the server, it decrypts the page contents and displays them to the user. The addresses associated with the links on the page are still encrypted because page address encryption was performed by the ACE at the server separately from the encrypted communication protocol. When the client browser sends a request, e.g. when a user clicks on an encrypted address on a web page, the request (i.e. the encrypted page address) is sent to the news service. As described in the previous paragraph, the form of the encrypted page address allows the global information network to direct the request to the server system, and at the same time protects the privacy and security of the client user from eavesdroppers. On the server side, the ACE decrypts the page address to obtain the entire client request in plain text, retrieves the specific information that the user requests, processes the information and encrypts the page addresses associated with the hyperlinks, and sends the information page to the user using an encrypted communication protocol. With this system, security and privacy of the client users can be assured.

There are many possible embodiments for the ACE. In one embodiment, the ACE is a software module integrated into the server software. In another embodiment, the ACE is a piece of hardware on the server side. These preferred embodiments only serve as examples of possible implementations. One who is skilled in the art can implement the ACE using many different hardware and/or software embodiments.

A secure browser-based information system can be used for many purposes. In one application, the information comprises Usenet newsgroups and news articles. Client users can use a browser to access Usenet news in a secure manner. This is more convenient than the traditional method of reading Usenet news, in which a user is required to install client news software that supports the Network News Transfer Protocol (NNTP). The browser based system only requires a browser, which recently has become a standard component in client computing machines. In another application, the secure information system comprises a secure electronic bulletin system that supports clients for posting articles, reading articles posted by others, as well as replying to previously posted articles. In a third application, the aforementioned secure electronic bulletin system can be used by a commercial business to provide secure customer support message board services, as well as to provide a secure product information database application. In all these applications, the secure system in this invention protects the end-to-end security of the client user.

### BRIEF DESCRIPTION OF THE DRAWINGS

FIG. 1 is a system diagram of secure browser-based information service, showing an information server, a page server, an address cryptographic engine (ACE), and a storage means on the server side, as well as a browser on the client side. In this system the ACE performs both page address encryption/decryption, and handles communication with the client browser using a secure communication protocol.

FIG. 2 shows the server side architecture scaled up for handling a large number of client users.

FIG. 3 shows another embodiment of the secure browser-based information system where the ACE only performs the page address encryption and decryption procedures. The page server is responsible for communicating with the client browsers via an encrypted communication protocol.

### DETAILED DESCRIPTION OF THE PREFERRED EMBODIMENTS

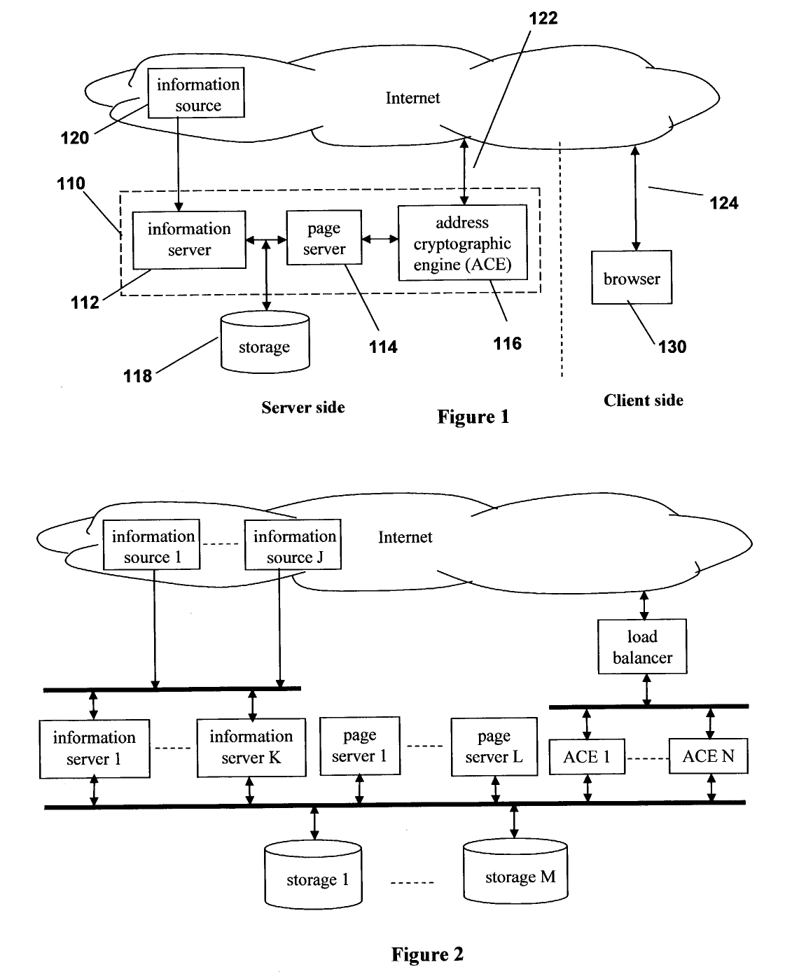

The present invention concerns a method for providing an end-to-end secure browser-based information service. FIG. 1 illustrates one embodiment of a secure browser-based information system 110 with an information server 112, a page server 114, an address cryptographic engine 116 and a storage means 118 on the server side. The information server obtains information contents from at least one information source 120 over the global information network. Example of information contents can include newsgroups and news articles information. The information is organized and stored at a storage means 118. When the secure browser-based information system receives a request from a client browser 130 for information content, the page server organizes and formats information into at least one information page. The information page can contain hyperlinks to other information contents such as other news articles, and each hyperlink is associated with a page address that identifies the appropriate information content. One purpose of the address cryptographic engine (ACE) is to encrypt the page addresses associated with links on the information pages so that the page addresses do not reveal information on the activities of the client users (e.g. specific information pages or articles that the client requests).

Generally, a page address consists of two parts: one part of the page address identifies the server, and another part of the page address identifies the information content such as a news article identification tag. The ACE at the server system encrypts only the portion of the page address that specifies the information content. The part that identifies the server is left unchanged. As a result, when a browser sends an encrypted page address in response to a user action, e.g. clicking on a link on the browser display, the global information network is able to identify the server system and directs the client request (i.e. the encrypted page address) to the server. At the same time, the encrypted page addresses do not reveal information on the specific information content that the client requests.

After the ACE has encrypted the page addresses associated with the links on the information page, the contents of the information page (except the page addresses associated with the hyperlinks) are still in plain text. In one embodiment of the invention illustrated in FIG. 1, the ACE performs encrypted communication 122 and 124 with client browsers. That is, it transmits the page to the client user using an encrypted communication protocol. This means the ACE encrypts the page content using an encryption key established in conjunction with the browser, and then transmits the encrypted page to the browser over the global information network.

When the page is received, the client browser decrypts the information page and displays the page in plain text to the client user. However, the page addresses associated with the links on the page are still encrypted because the encryption of the page addresses was performed by the ACE separately from the encrypted communication protocol.

When the client user requests other information contents by clicking on a link in the information page, the encrypted page address associated with the link is sent as a request to the secure browser-based information system. As mentioned before, the portion of the page address that identifies the server is not encrypted, hence the global information will be able to route the request to the secure information system. When this encrypted page address is received by the secure information system, the encrypted page address is decrypted by the ACE. The secure information system then retrieves the appropriate information content and formatted it into an information page for the client. Therefore, another purpose of the ACE in the secure browser-based information system is to decrypt the encrypted page address received from the clients.

In an embodiment of the system, the ACE can optionally perform authentication for the user. In this embodiment, the ACE embeds a user identification tag into the page address before the address is encrypted. When such an encrypted page address is sent from the browser as a result of, e.g. a user clicking on a hyperlink associated with the encrypted page address, the secure information system receives the encrypted page address and sends it to the ACE for decryption. Once the page address is decrypted, the secure information system can authenticate the user using the user identification tag. For example, the system can check whether the user is still logged in, and take an appropriate action depending on whether the user is logged in or not. In another example, the system can check the network address of the client and determine if the network address of the client has changed within the session. This helps to prevent an eavesdropper from intercepting the page request and then re-playing the request to the server from a different network location to obtain information.

An example application of the secure browser-based information system is to provide secure browser-based access to Usenet newsgroups for clients over the World Wide Web. In this example each page address comprises a uniform resource locator (URL), and the page server comprises a web server. Hence the ACE performs URL encryption and decryption for the secure browser-based news system in this example. In one embodiment of the invention illustrated in FIG. 1, the ACE further comprises a means for communicating with at least one client browser using an encrypted communications protocol. One example of such an ACE comprises a means to support Secure Socket Layer (SSL).

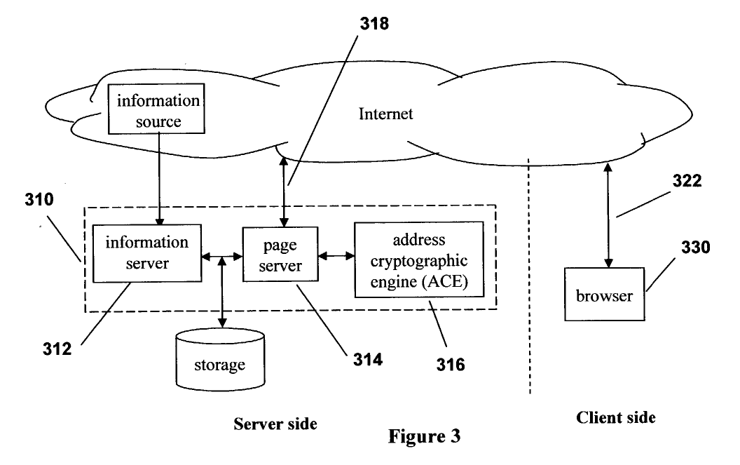

In another embodiment of the invention illustrated in FIG. 3, encrypted communication 318 and 322 between the secure browser-based information system 310 and the client is performed by the page server 314 on the server side. In this embodiment, the information server 312 obtains information content from at least one information source. When the information system receives a request from a client user, the page server formats information contents into at least one information page, and sends the page address associated with the links on the information pages to the ACE 316 for encryption. When the page server receives the encrypted page addresses from the ACE, the page server inserts the encrypted page addresses into the information pages. At this stage, only the page addresses associated with the links on the information page is encrypted. The contents of the information page are still in plain text. The page server sends the information page to the client browser 330 using and encrypted communication protocol. The client browser decrypts the information page and displays it to the client user. At this point, the content of the page is displayed in plain text on the client browser. However, the page addresses associated with the links on the page are encrypted.

In the following, we use an example to describe in further detail the operations of the secure browser-based information system. In this example, the secure browser-based information system works within the infrastructure of the World Wide Web. Hence in this example, the client users use web browsers to obtain information content which are formatted into web pages by at least one web server in the secure information system. The web page addresses are Uniform Resource Locators (URL's), and the encrypted communication protocol used between the web browser and the web server comprises Secure Socket Layer (SSL). It is noted that we use the WWW as an example for ease of description. A person who is skilled in the art can implement and apply the secure browser-based information system to other infrastructures of the global information system.

When a client user connects to the secure web based information service using a web browser, an initial web page is sent to the browser via SSL. In one embodiment, this initial page contains a login interface for the client user to login. After the user is logged in, i.e., after the user is identified by the system, the secure information system serves a page that contains information contents as well as navigation links for the client user to navigate around the information system, download information contents, post information articles, and perform other operations such as account updating. In another embodiment, the system does not require the user to login. When a user initiates a connection, the system simply sends a page with some initial information content and navigation links to the user. In this second embodiment, the system can generate a session identification tag, when necessary, for identification and authentication purposes.

Since the communication between the web browser and the secure web-based news system is performed via SSL, the content of the information pages are safe against eavesdroppers. When the page content reaches the client browser, the client browser decrypts the page content and then displays the page to the user.

In a web page, there are hyper links that provide navigation ability. Each hyper link is associated with a URL. When a client user clicks on a hyperlink at the display, the browser sends a request using the URL of the selected hyperlink. Consider the case where the URL is not encrypted using the ACE in this invention. In this case, a clear text URL comprises the forms

https://siteaddress.com/userid/information_cotent_id

and

https://siteaddress.com?user=uid&content=id.

Here the “https” at the beginning of the URL indicates that the web server and the browser are communicating via SSL. Although the page contents are encrypted under SSL, the request for the page (i.e., the URL) from the browser is not encrypted by SSL. This is necessary because if the browser were to encrypt the page request using SSL, then the machines and routers in the global information network would not understand where the request should go to, and hence would not be able to direct the request to the server. Since the request (the URL) is not sent under SSL, an eavesdropper can intercept and see the exact plain text URL; hence an eavesdropper can find out what particular information content the client user is requesting.

This is a reason why in this invention, we use an ACE on the server side to encrypted the URL's associated with the hyperlinks on the information page before the page is sent to the client browser. This encryption operation is performed separately from SSL. In the forms of the URL's given above, there is a part “https://siteaddress.com/” that specifies the address of the secure browser-based information system. This is the part that is required by the global information network to direct the requests to the server, and hence this part cannot be encrypted. The rest of the URL specifies the information content, such as a news article identification tag or identifier. This is the part that the ACE would encrypt. After the ACE encrypts the second part, it then assembles the encrypted portion with the part that identified the site address to give encrypted URL's of the form

https://siteaddress.com/fdshjuihjdskj

where the string “fdshjuihjdskj” is an example of an encrypted string containing the information content identifier. If a client clicks a hyperlink on a page with an encrypted URL of this form, the machines in the global information network will be able to direct the request to the secure information system at the address “siteaddress.com”, and at the same time the specific information content being requested is kept secret from eavesdroppers. When this request is received by the secure browser-based information system, the ACE decrypts the URL, and then forwards the request to the page server to retrieve the appropriate information to be sent to the client.

We have now completed the description of the specific example. In the following, we discuss the advantages of the secure browser based information system.

In one embodiment of the secure browser-based information system, the encrypted string in the page address contains an identifier indicating the identity of the specific client user making the request. Consequently the ACE can use a client dependent key for encryption and decryption. This feature provides an important advantage in system security in that it prevents replay attacks. The reason is that if the encryption key is not client dependent, then an eavesdropper can perform a “replay attack” by simply sending the encrypted request to the information system and observe the page returned by the server system. With a client dependent key, the system can ensure that the client user is logged in (i.e. authenticated) before sending the information page, hence it protects against such replay attacks.

Another advantage of this invention is that the secure browser-based information system is compatible with existing infrastructure of the global information network. In order to use the secure browser-based information system, a client user only needs to have a standard browser and a standard connection to the global information network. There is no need to install any additional software or hardware on the client side.

A third advantage of this invention is that the ACE can be implemented on the server side in many different forms. FIG. 1 illustrates one embodiment of the design where the ACE also performs communication with the client user using an encrypted communication protocol. FIG. 2 shows an expanded server side architecture that can accommodate a very large number of client users. In another embodiment as illustrated in FIG. 3, the ACE comprises a module that only does page address encryption and decryption, whereas the page server takes up the responsibility of communicating with the client via a secure communication protocol. It is noted that in the three embodiments illustrated from FIG. 1 to FIG. 3, the client user can use the same equipment to access the news service. That is, these different embodiments on the server side do not affect the client side.

A fourth advantage of this invention is that a user identification tag or a session identification tag can be embedded in a page address before the ACE performs address encryption. Therefore the encrypted page address can be used by the secure browser-based information system to authenticate the user.

A secure browser-based information system can be used for many purposes. In one application, the news information comprises Usenet newsgroups and news articles. Client users can use a browser to read Usenet newsgroups and news articles. This is more convenient than the traditional method of reading Usenet news, in which a user needs to install client news software that supports the Network News Transfer Protocol. The secure browser-based news system does not require any additional client news software. In another application, the secure information system comprises a secure electronic bulletin system that supports clients to post articles, read articles posted by others, as well as reply to previously posted articles. In a third application, the aforementioned secure electronic bulletin system can be used by a business to provide secure customer support message boards and provide secure product information database. In all these applications, the secure system in this invention protects the security of the client user from being eavesdropped.

We have described a secure browser-based information system that provides end-to-end security in providing information services. The description will allow people with ordinary skill in the art to construct a similar secure information system comprising an information server, a page server, a storage means, and an address cryptographic engine. Therefore the preferred embodiments are meant to be examples for illustrating the key components of the invention and should not be taken as the only embodiments that are possible with this invention.

What is claimed is:

1. A method of providing a secure browser-based information service comprising the following steps:
i. providing an information server for obtaining information from at least one information source,
ii. providing a storage means for storing said information,
iii. providing a page server for formatting said information into at least one information page,
iv. providing a cryptographic engine for encrypting the information page addresses associated with hyperlinks in said information page into encrypted information page addresses before transmitting said information page to a client, and for decrypting said encrypted information page address from a page request received from said client.

2. The method of claim 1 wherein an encrypted communication protocol is used for transmitting said information page to said client.

3. The method of claim 1 wherein said cryptographic engine uses at least one client dependent cryptographic key.

4. The method of claim 1 wherein said cryptographic engine embeds at least one client dependent identification tag into said encrypted page address.

5. The method of claim 1 wherein said secure browser-based information service comprises a secure browser-based news service, and said information comprises newsgroups and news articles.

6. The method of claim 1 wherein said secure browser-based information service comprises at least one secure electronic bulletin board service.

7. The method of claim 6 wherein said secure electronic bulletin board service further comprises at least one secure customer support service.

8. The method of claim 1 wherein said secure browser-based information service comprises a secure product information database service.

9. A secure browser-based information system comprising
i. an information server for obtaining information from at least one information source,
ii. a storage means for storing said information,
iii. a page server for formatting said information into at least one information page,
iv. a cryptographic engine for encrypting the information page addresses associated with hyperlinks in said information page into encrypted information page addresses before transmitting said information page to a client, and for decrypting said encrypted information page address from a page request received from said client.

10. The method of claim 9 wherein an encrypted communication protocol is used for transmitting said information page to said client.

11. The method of claim 9 wherein said cryptographic engine uses at least one client dependent cryptographic key.

12. The method of claim 9 wherein said cryptographic engine embeds at least one client dependent identification tag into said encrypted page address.

13. The method of claim 9 wherein said secure browser-based information system comprises a secure browser-based news system, and said information comprises newsgroups and news articles.

14. The method of claim 9 wherein said secure browser-based information system comprises at least one secure electronic bulletin board system.

15. The method of claim 14 wherein said secure electronic bulletin board system further comprises at least one secure customer support system.

16. The method of claim 9 wherein said secure browser-based information system comprises a secure product information database system.

17. A secure web-based news system comprising
i. a news server for obtaining news information from at least one newsfeed,
ii. a storage means for storing said news information,
iii. a web server for formatting said news information into at least one web page,
iv. a cryptographic engine for encrypting the Uniform Resource Locators (URL's) associated with hyperlinks in said web page into encrypted URL's before transmitting said web page to a client, and for decrypting said encrypted URL from a page request received from said client.

18. The system of claim 17 wherein SSL is used for transmitting said web page to said client.

19. The system of claim 17 wherein said cryptographic engine uses at least one client dependent cryptographic key.

20. The system of claim 17 wherein said cryptographic engine embeds at least one client dependent identification tag into said encrypted URL's.
